(19) United States
(12) Patent Application Publication
(10) Pub. No.: US 2022/0366215 A1
(43) Pub. Date: Nov. 17, 2022

(54) APPLYING A CONVOLUTION KERNEL ON INPUT DATA

(71) Applicant: Mobileye Vision Technologies Ltd., Jerusalem (IL)

(72) Inventors: Orly WEISEL, Efrat (IL); Yaniv FAIS, Tel Aviv (IL); Shira HIRSCH, Jerusalem (IL); Daniel SREBNIK, Jerusalem (IL)

(21) Appl. No.: 17/739,834

(22) Filed: May 9, 2022

Related U.S. Application Data
(60) Provisional application No. 63/187,580, filed on May 12, 2021.

(51) Int. Cl. G06N 3/04; G06F 7/523; G06F 7/50

(52) U.S. Cl. CPC G06N 3/04; G06F 7/523; G06F 7/50

(57) ABSTRACT

A method for neural network convolution, the method may include receiving input data that is a 3D input data and comprises input data segments associated with different input data depth values; receiving a convolution kernel that is a 3D convolution kernel and comprises kernel segments associated with different kernel depth values; performing multiple 3D convolution iteration, wherein each of 3D convolution iteration comprises: determining whether the 3D convolution iteration is of a first type or of a second type; executing the 3D convolution iteration of the first type when determining that the 3D convolution iteration is of the first type; and executing the 3D convolution iteration of the second type when determining that the 3D convolution iteration is of the second type.

### PRIORITY

This application claims the benefit of priority to U.S. Provisional Patent Application Ser. No. 63/187,580, filed May 12, 2021, which is incorporated by reference herein in its entirety.

### BACKGROUND

Advanced driver assistance systems (ADAS), and autonomous vehicle (AV) systems use cameras and other sensors together with object classifiers, which are designed to detect specific objects in an environment of a vehicle navigating a road. Object classifiers are designed to detect predefined objects and are used within ADAS and AV systems to control the vehicle or alert a driver or operator based on the type of object that is detected its location, etc.

ADAS and AV systems may process images received from one or more vehicle sensors. The images may be processed by one or more convolution neural networks (CNNs) for various purposes, such as detecting specific features within the received images. The image feature detection may include object detection, image classification, image segmentation, or other image feature detection. The feature detection may be implemented within each CNN by applying a convolution kernel (e.g., convolution filter) to input images to generate a feature detection map (e.g., activation map).

Some of the CNN processing of received images may include padding two dimensional (2D) segments of input with zeros, such as in both X and Y directions. The processing may be executed by CNN processors that are configured to execute 2D convolution operations. There is a growing need to perform three dimensional (3D) convolution operation instead of or in addition to 2D convolution. There is a growing need perform the convolution operations in an efficient manner, such as by using CNN processors that are configured to execute 2D convolution operations.

### SUMMARY

The present subject matter provides technical solutions facing technical problems associated with CNN processors that are configured to execute 2D convolution operations (e.g., 2D-configured CNN processors). These technical solutions to this technical problem include determining whether a convolution iteration is of a first type or a second type, and replacing an inefficient convolution iteration by an efficient convolution iteration when the convolution iteration is determined to be of the second type.

The convolution kernel operations described herein provide systems and methods that can be used as part of or in combination with autonomous navigation, autonomous driving, or driver assist technology features. As opposed to fully autonomous driving, driver assist technology may refer to any suitable technology to assist drivers in the navigation or control of their vehicles. Examples of driver assist technology include Forward Collision Warning (FCW), Lane Departure Warning (LDW), Traffic Sign Recognition (TSR), and other driver assist technologies. The convolution kernel operations described herein may receive inputs from various sensors, such as one or more cameras mountable in a vehicle and an associated processor that monitors the environment of the vehicle, depth sensors (e.g., lidar, radar), and additional types of sensors and associated processors mounted in the vehicle. In some examples of the presently disclosed subject matter, the system may provide techniques for processing images of an environment in advance of a vehicle navigating a road, where the processing including training neural networks or deep learning algorithms to estimate a future path of a vehicle based on images. In yet further examples of the presently disclosed subject matter, the system may provide techniques for processing images of an environment in advance of a vehicle navigating a road using a trained neural network to estimate a future path of the vehicle. In particular, the convolution kernel operations described herein provide improved object detection, improved classification of object (e.g., cars, pedestrians), improved object distance estimation (e.g., depth estimation), improved identification and annotation of vehicular navigation “free space” (e.g., nearby roads, sidewalks), improved detection and identification of traffic signs and road user behaviors (e.g., walking direction of nearby pedestrians).

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples.

There are provided systems and methods, as illustrated in the claims and the specification. Any combination of any subject matter of any claim may be provided. Any combination of any method or method step disclosed in any figure or in the specification may be provided. Any combination of any unit, device, or component disclosed in any figure or in the specification may be provided. Non-limiting examples of such units include a gather unit, an image processor, and the like.

### BRIEF DESCRIPTION OF THE DRAWINGS

The subject matter regarded as the subject matter is particularly pointed out and distinctly claimed in the concluding portion of the specification. The subject matter, however, both as to organization and method of operation, together with objects, features, and advantages thereof, may best be understood by reference to the following detailed description when read with the accompanying drawings in which:

FIG. 1 is a block diagram representation of a system consistent, with the disclosed embodiments;

FIG. 2A is a diagrammatic side view representation of an exemplary vehicle including a system, consistent with the disclosed embodiments;

FIG. 2B is a diagrammatic top view representation of the vehicle and system shown in FIG. 2A, consistent with the disclosed embodiments;

FIG. 2C is a diagrammatic top view representation of another embodiment of a vehicle including a system, consistent with the disclosed embodiments;

FIG. 2D is a diagrammatic top view representation of yet another embodiment of a vehicle including a system, consistent with the disclosed embodiments;

FIG. 2E is a diagrammatic representation of exemplary vehicle control systems, consistent with the disclosed embodiments;

FIG. 3 is a diagrammatic representation of a user interface, consistent with the disclosed embodiments;

FIG. 4 illustrates an example of input data segments, padded input data segments and virtual padding segments, consistent with the disclosed embodiments;

FIG. 5 illustrates an example of kernel segments, and output segments, consistent with the disclosed embodiments;

FIG. 6 illustrates an example of various steps of convolution iterations, consistent with the disclosed embodiments;

FIG. 7 illustrates an example of various steps of convolution iterations, consistent with the disclosed embodiments;

FIG. 8 illustrates an example of various steps of convolution iterations, consistent with the disclosed embodiments, consistent with the disclosed embodiments;

FIG. 9 illustrates an example of a method, consistent with the disclosed embodiments; and

FIG. 10 illustrates an example of a device, consistent with the disclosed embodiments.

### DETAILED DESCRIPTION OF THE DRAWINGS

In the following detailed description, numerous specific details are set forth in order to provide a thorough understanding of the subject matter. However, it will be understood by those skilled in the art that the present subject matter may be practiced without these specific details. In other instances, well-known methods, procedures, and components have not been described in detail so as not to obscure the present subject matter.

Technical solutions to technical problems associated with 2D-configured CNN processors include determining whether a convolution iteration is of a first type or a second type, and replacing an inefficient convolution iteration by an efficient convolution iteration when the convolution iteration is determined to be of the second type. In particular, the efficient convolution iteration includes skipping calculation of element-wise multiplications and addition operations between elements of the first kernel segment and elements of the virtual padding segment. In an example of this solution, during convolution iteration of a second type, the efficiency of the calculation of element-wise multiplications and additions operations between elements of the first kernel segment and elements of the virtual padding segment is improved by:
(a) replacing the elements of the first kernel segment by zero-valued elements; and
(b) performing element-wise multiplications and additions operations between the zero-valued elements and elements of one of the input data segments.

In another example of this solution, during convolution iteration of a second type, the calculation of element-wise multiplications and additions operations between elements of the first kernel segment and elements of the virtual padding segment may be replaced by setting a zero-value to an outcome of the calculation of element-wise multiplications and additions operations between elements of the first kernel segment and elements of the virtual padding segment. This may include not calculating any sum and performing fewer sum operations in any sub-iteration.

These technical solutions reduce or eliminate issues associated with using 2D-configured CNN processors when padding is involved, where 3D padding that is used in 3D convolution may not be executed by some 2D-configured CNN processors. In particular, this provides the ability to generate padding layers virtually, which may not be possible using a 2D-configured CNN processor.

The subject matter is particularly pointed out and distinctly claimed in the concluding portion of the specification. The subject matter, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present subject matter may be implemented using electronic components and circuits known to those skilled in the art, details will not be explained in any greater extent than that considered necessary for the understanding and appreciation of the underlying concepts of the present subject matter and in order not to obfuscate or distract from the teachings of the present subject matter.

Any reference in the specification to a method should be applied mutatis mutandis to a system capable of executing the method, and should be applied mutatis mutandis to a non-transitory computer readable medium that stores instructions that, once executed by a computer, result in the execution of the method.

Any reference in the specification to a system and any other component should be applied mutatis mutandis to a method that may be executed by the memory device, and should be applied mutatis mutandis to a non-transitory computer readable medium that stores instructions that may be executed by the memory device. For example, there may be provided a method or method steps executed by the image processor, or there may be provided a method or method steps executed by the image processor.

Any reference in the specification to a non-transitory computer readable medium should be applied mutatis mutandis to a system capable of executing the instructions stored in the non-transitory computer readable medium, and should be applied mutatis mutandis to method that may be executed by a computer that reads the instructions stored in the non-transitory computer readable medium.

Any combination of any module or unit listed in any of the figures, any part of the specification, or any claims may be provided. Especially any combination of any claimed feature may be provided.

Various possible implementations and configurations of a vehicle-mountable system may be used for carrying out and implementing the methods according to examples of the presently disclosed subject matter. This vehicle-mountable system may be used to implement features of the present subject matter, such as processing images of an environment ahead of a vehicle navigating a road for training a neural networks or deep learning algorithms to estimate a future path of a vehicle based on images or feature of the processing of images of an environment ahead of a vehicle navigating a road using a trained neural network to estimate a future path of the vehicle. In some embodiments, various examples of the system may be mounted in a vehicle, and may be operated while the vehicle is in motion. In some embodiments, the system may implement the methods according to examples of the presently disclosed subject matter.

Embodiments of the present disclosure may include image-based identification of an upright object within the field of view of the vehicle. In some embodiments, a suspected upright object indication may be caused by a high-grade road. The suspected upright object indication may be associated with various other circumstances, and may result from other types of image data and also from data that is not image based or is not exclusively image based.

There may be provided a processing device that may include, for example, processors available from manufacturers such as Intel®, AMD®, etc. and may include various architectures (e.g., x86 processor, ARM®, etc.). There may be provided a device that may include, for example, any of the EyeQ series of processor chips available from Mobileye®. These processor designs each include multiple processing units with local memory and instruction sets. Such processors may include video inputs for receiving image data from multiple image sensors and may also include video out capabilities. In one example, the EyeQ2® uses 90 nm-micron technology operating at 332 Mhz. The EyeQ2® architecture has two floating point, hyper-thread 32-bit RISC CPUs (MIPS32® 34K® cores), five Vision Computing Engines (VCE), three Vector Microcode Processors (VMP®), Denali 64-bit Mobile DDR Controller, 128-bit internal Sonics Interconnect, dual 16-bit Video input and 18-bit Video output controllers, 16 channels DMA and several peripherals. The MIPS34K CPU manages the five VCEs, three VMP.™ and the DMA, the second MIPS34K CPU and the multi-channel DMA as well as the other peripherals. The five VCEs, three VMP® and the MIPS34K CPU may perform intensive vision computations required by multi-function bundle applications. In another example, the EyeQ3®, which is a third-generation processor and is six times more powerful that the EyeQ2®, may be used in the disclosed examples. In yet another example, the EyeQ4®, the fourth-generation processor, may be used in the disclosed examples.

There may be provided a device that may include a controller, an image preprocessor, a central processing unit (CPU), support circuits, digital signal processors, integrated circuits, memory, or any other types of devices for image processing and analysis. The image preprocessor may include a video processor for capturing, digitizing, and processing the imagery from the image sensors. The CPU may include any number of microcontrollers or microprocessors. The support circuits may be any number of circuits generally well known in the art, including cache, power supply, clock, and input-output circuits. The memory may store software that, when executed by the processor, controls the operation of the system. The memory may include databases and image processing software, including a trained system, such as a neural network, for example. The memory may include any number of random access memories, read only memories, flash memories, disk drives, optical storage, removable storage, and other types of storage.

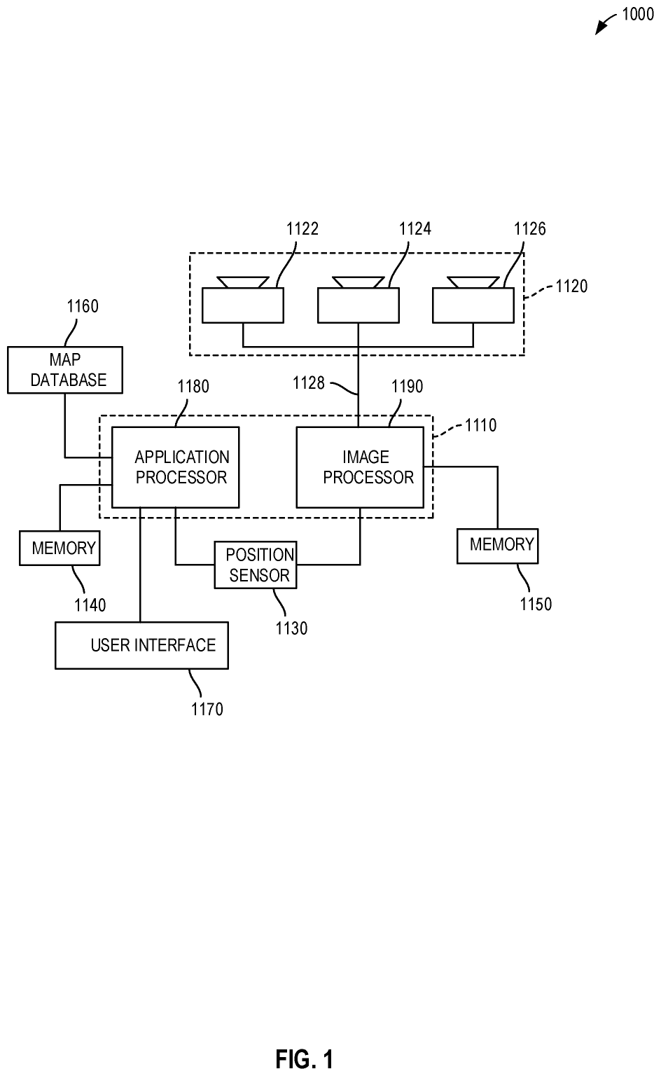

FIG. 1, to which reference is now made, is a block diagram representation of a system consistent with the disclosed embodiments. System 1000 can include various components depending on the requirements of a particular implementation. In some examples, system 1000 can include a processing unit 1110, an image acquisition unit 1120, and one or more memory units 1140, 1150. Processing unit 1110 can include one or more processing devices. In some embodiments, processing unit 1110 can include an application processor 1180, an image processor 1190, or any other suitable processing device. Similarly, image acquisition unit 1120 can include any number of image acquisition devices and components depending on the requirements of a particular application. In some embodiments, image acquisition unit 1120 can include one or more image capture devices (e.g., cameras), such as image capture device 1122, image capture device 1124, and image capture device 1126. In some embodiments, system 1000 can also include a data interface 1128 communicatively connecting processing unit 1110 to image acquisition device 1120. For example, data interface 1128 can include any wired or wireless link or links for transmitting image data acquired by image acquisition device 1120 to processing unit 1110.

Both application processor 1180 and image processor 1190 can include various types of processing devices. For example, either or both of application processor 1180 and image processor 1190 can include one or more microprocessors, preprocessors (such as image preprocessors), graphics processors, central processing units (CPUs), support circuits, digital signal processors, integrated circuits, memory, or any other types of devices suitable for running applications and for image processing and analysis. In some embodiments, application processor 1180 or image processor 1190 can include any type of single or multi-core processor, mobile device microcontroller, central processing unit, or other type of processor. Various processing devices can be used, for example including processors available from manufacturers (e.g., Intel®, AMD®, etc.), and can include various architectures (e.g., x86 processor, ARM®, etc.).

In some embodiments, application processor 1180 or image processor 1190 can include any of the EyeQ series of processor chips available from Mobileye®. These processor designs each include multiple processing units with local memory and instruction sets. Such processors may include video inputs for receiving image data from multiple image sensors, and may also include video out capabilities. In one example, the EyeQ2® uses 90 nm-micron technology operating at 332 Mhz. The EyeQ2® architecture has two floating point, hyper-thread 32-bit RISC CPUs (MIPS32® 34K® cores), five Vision Computing Engines (VCE), three Vector Microcode Processors (VMP®), Denali 64-bit Mobile DDR Controller, 128-bit internal Sonics Interconnect, dual 16-bit Video input and 18-bit Video output controllers, 16 channels DMA and several peripherals. The MIPS34K CPU manages the five VCEs, three VMP®, the DMA, the second MIPS34K CPU, the multi-channel DMA, and the other peripherals. The five VCEs, three VMP® and the MIPS34K CPU can perform intensive vision computations required by multi-function bundle applications. In another example, the EyeQ3®, which is a third-generation processor and is six times more powerful that the EyeQ2®, may be used in the disclosed examples. In yet another example, the EyeQ4®, the fourth-generation processor, may be used in the disclosed examples.

While FIG. 1 depicts two separate processing devices included in processing unit 1110, more or fewer processing devices can be used. For example, in some examples, a single processing device may be used to accomplish the tasks of application processor 1180 and image processor 1190. In other embodiments, these tasks can be performed by more than two processing devices.

Processing unit 1110 can include various types of devices. For example, processing unit 1110 may include various devices, such as a controller, an image preprocessor, a central processing unit (CPU), support circuits, digital signal processors, integrated circuits, memory, or any other types of devices for image processing and analysis. The image preprocessor can include a video processor for capturing, digitizing, and processing the imagery from the image sensors. The CPU can include any number of microcontrollers or microprocessors. The support circuits can be any number of circuits generally well known in the art, including cache, power supply, clock, and input-output circuits. The memory can store software that, when executed by the processor, controls the operation of the system. The memory can include databases and image processing software, including a trained system, such as a neural network, for example. The memory can include any number of random-access memories (RAM), read only memories (ROM), flash memories, disk drives, optical storage, removable storage, and other types of storage. In one instance, the memory can be separate from the processing unit 1110. In another instance, the memory can be integrated into the processing unit 1110.

Each memory 1140, 1150 can include software instructions that when executed by a processor (e.g., application processor 1180 or image processor 1190), can control operation of various aspects of system 1000. These memory units can include various databases and image processing software. The memory units can include random access memory, read only memory, flash memory, disk drives, optical storage, tape storage, removable storage, or any other types of storage. In some examples, memory units 1140, 1150 can be separate from the application processor 1180 or image processor 1190. In other embodiments, these memory units can be integrated into application processor 1180 or image processor 1190.

In some embodiments, the system can include a position sensor 1130. The position sensor 1130 can include any type of device suitable for determining a location associated with at least one component of system 1000. In some embodiments, position sensor 1130 can include a global positioning system (GPS) receiver. Such receivers can determine a user position and velocity by processing signals broadcasted by GPS satellites. Position information from position sensor 1130 can be made available to application processor 1180 or image processor 1190.

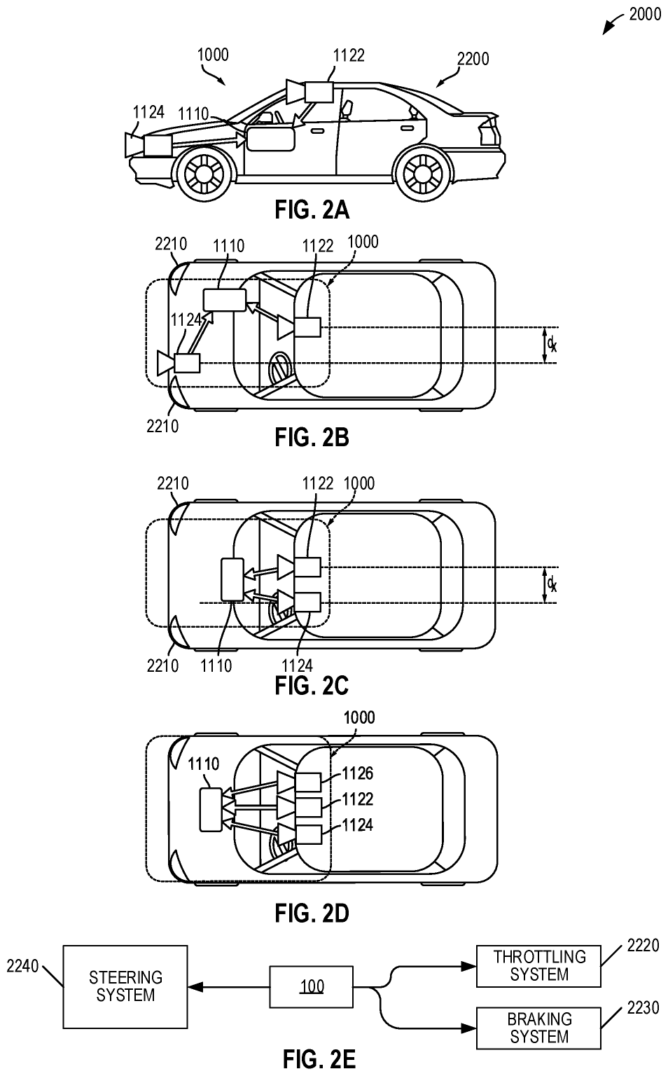

In some embodiments, the system 1000 can be operatively connectible to various systems, devices, and units onboard a vehicle in which the system 1000 can be mounted, and through any suitable interfaces (e.g., a communication bus) the system 1000 can communicate with the vehicle's systems. Examples of vehicle systems with which the system 1000 can cooperate include a throttling system, a braking system, and a steering system (e.g., throttling system 2220, braking system 2230, and steering system 2240 of FIG. 2E).

In some embodiments, the system 1000 can include a user interface 1170. User interface 1170 can include any device suitable for providing information to or for receiving inputs from one or more users of system 1000, for example including a touchscreen, microphone, keyboard, pointer devices, track wheels, cameras, knobs, buttons, etc. Information can be provided by the system 1000, through the user interface 1170, to the user.

In some embodiments, the system 1000 can include a map database 1160. The map database 1160 can include any type of database for storing digital map data. In some examples, map database 1160 can include data relating to a position, in a reference coordinate system, of various items, including roads, water features, geographic features, points of interest, etc. Map database 1160 can store not only the locations of such items, but also descriptors relating to those items, for example including names and other information associated with any of the stored features. For example, the database may include locations and types of known obstacles, information about a topography of a road or a grade of certain points along a road, etc. In some embodiments, map database 1160 can be physically located with other components of system 1000. Map database 1160 or a portion thereof may be located remotely with respect to other components of system 1000 (e.g., processing unit 1110). In such remote embodiments, information from map database 1160 can be downloaded over a wired or wireless data connection to a network (e.g., over a cellular network or the Internet, etc.).

Image capture devices 1122, 1124, and 1126 can each include any type of device suitable for capturing at least one image from an environment. Moreover, any number of image capture devices can be used to acquire images for input to the image processor. Some examples of the presently disclosed subject matter can include or can be implemented with only a single-image capture device, while other examples can include or can be implemented with two, three, four, or more image capture devices. Image capture devices 1122, 1124, and 1126 will be further described with reference to FIGS. 2B-2E, below.

It would be appreciated that the system 1000 can include or can be operatively associated with other types of sensors, for example including an acoustic sensor, a radio frequency (RF) sensor (e.g., radar transceiver), a LIDAR sensor, or other sensors. Such sensors can be used independently of or in cooperation with the image acquisition device 1120. For example, data from a radar system (not shown) can be used for validating the processed information that is received from processing images acquired by the image acquisition device 1120, such as to filter certain false positives resulting from processing images acquired by the image acquisition device 1120. Data from a radar system can also be combined with or otherwise compliment the image data from the image acquisition device 1120, or be combined with some processed variation or derivative of the image data from the image acquisition device 1120.

System 1000, or various components thereof, can be incorporated into various different platforms. In some embodiments, system 1000 may be included on a vehicle 2200, as shown in FIG. 2A. For example, vehicle 2200 can be equipped with a processing unit 1110 and any of the other components of system 1000, as described above relative to FIG. 1. While in some embodiments, vehicle 2200 can be equipped with only a single-image capture device (e.g., camera), in other embodiments multiple image capture devices can be used, such as those discussed in connection with FIGS. 2B-2E, multiple image capture devices can be used. For example, either of image capture devices 1122 or 1124 of vehicle 2200, as shown in FIG. 2A, can be part of an ADAS (Advanced Driver Assistance Systems) imaging set.

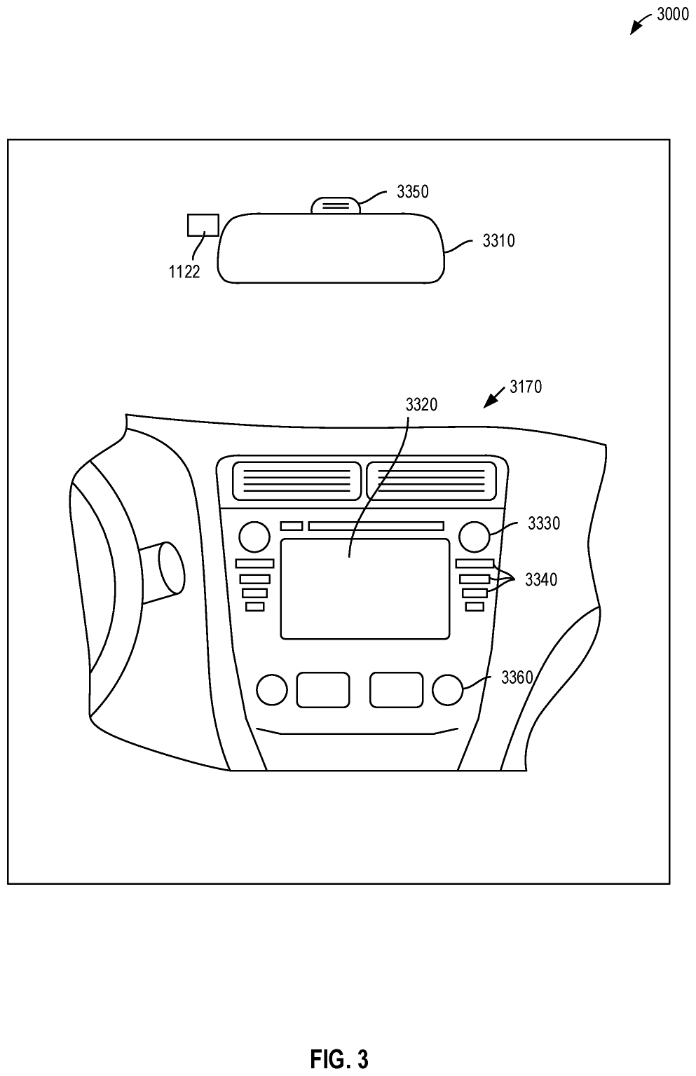

The image capture devices included on vehicle 2200 as part of the image acquisition unit 1120 can be positioned at any suitable location. In some embodiments, as shown in FIGS. 2A-2E and FIG. 3, image capture device 1122 can be located in the vicinity of the rearview mirror (e.g., mirror 3310 of FIG. 3). This position may provide a line of sight similar to that of the driver of vehicle 2200, which can aid in determining what is and is not visible to the driver.

Other locations for the image capture devices of image acquisition unit 1120 can also be used. For example, image capture device 1124 can be located on or in a bumper of vehicle 2200. Such a location can be especially suitable for image capture devices having a wide field of view. The line of sight of bumper-located image capture devices can be different from that of the driver. The image capture devices (e.g., image capture devices 1122, 1124, and 1126) can also be located in other locations. For example, the image capture devices may be located on or in one or both of the side mirrors of vehicle 2200, on the roof of vehicle 2200, on the hood of vehicle 2200, on the trunk of vehicle 2200, on the sides of vehicle 2200, mounted on, positioned behind, or positioned in front of any of the windows of vehicle 2200, and mounted in or near vehicle lights on the front or back of vehicle 2200, or in other locations. The image capture unit 1120, or an image capture device that is one of a plurality of image capture devices that are used in an image capture unit 1120, can have a field-of-view (FOV) that is different than the FOV of a driver of a vehicle, and not always see the same objects. In one example, the FOV of the image acquisition unit 1120 can extend beyond the FOV of a typical driver and can thus image objects which are outside the FOV of the driver. In yet another example, the FOV of the image acquisition unit 1120 is some portion of the FOV of the driver. In some embodiments, the FOV of the image acquisition unit 1120 corresponding to a sector which covers an area of a road in advance of a vehicle and possibly also surroundings of the road.

In addition to image capture devices, vehicle 2200 can be include various other components of system 1000. For example, processing unit 1110 may be included on vehicle 2200 either integrated with or separate from an engine control unit (ECU) of the vehicle 2200. Vehicle 2200 may also be equipped with a position sensor 1130, such as a GPS receiver and may also include a map database 1160 and memory units 1140 and 1150.

FIG. 2A is a diagrammatic side view representation of a vehicle imaging system according to examples of the presently disclosed subject matter. FIG. 2B is a diagrammatic top view illustration of the example shown in FIG. 2A. As illustrated in FIG. 2B, the disclosed examples can include a system 1000 within a vehicle 2200. The system 1000 may include a first image capture device 1122 positioned in the vicinity of the rearview mirror or near the driver of vehicle 2200, a second image capture device 1124 positioned on or in a bumper region (e.g., one of bumper regions 2210) of vehicle 2200, and a processing unit 1110.

As illustrated in FIG. 2C, image capture devices 1122 and 1124 may both be positioned in the vicinity of the rearview mirror or near the driver of vehicle 2200. Additionally, while two image capture devices 1122 and 1124 are shown in FIGS. 2B and 2C, it should be understood that other embodiments may include more than two image capture devices. For example, in the embodiment shown in FIG. 2D, system 1000 includes a first image capture device 1122, a second image capture device 1124, and a third image capture device 1126.

As shown in FIG. 2D, image capture devices 1122, 1124, and 1126 may be positioned in the vicinity of the rearview mirror or near the driver seat of vehicle 2200. The disclosed examples are not limited to any particular number and configuration of the image capture devices, and the image capture devices may be positioned in any appropriate location within or on vehicle 2200. It is also to be understood that disclosed embodiments are not limited to a particular type of vehicle 2200 and may be applicable to all types of vehicles including automobiles, trucks, trailers, motorcycles, bicycles, self-balancing transport devices and other types of vehicles.

The first image capture device 1122 can include any suitable type of image capture device. Image capture device 1122 can include an optical axis. In one instance, the image capture device 1122 can include an Aptina M9V024 WVGA sensor with a global shutter. In another example, a rolling shutter sensor can be used. Image acquisition unit 1120, and any image capture device which is implemented as part of the image acquisition unit 1120, can have any desired image resolution. For example, image capture device 1122 can provide a resolution of 1280×960 pixels and can include a rolling shutter. As used herein, a pixel may include a picture element obtained by a camera, or may include a processed picture element.

Image acquisition unit 1120, and any image capture device that is implemented as part of the image acquisition unit 1120, can include various optical elements. In some embodiments, one or more lenses can be included, such as to provide a desired focal length and field of view for the image acquisition unit 1120. These lenses may be used for any image capture device that is implemented as part of the image acquisition unit 1120. In some examples, an image capture device that is implemented as part of the image acquisition unit 1120 can include or can be associated with any optical elements, such as a 6 mm lens or a 12 mm lens. In some examples, image capture device 1122 can be configured to capture images having a desired and known FOV. The first image capture device 1122 may have a scan rate associated with acquisition of each of the first series of image scan lines. The scan rate may refer to a rate at which an image sensor can acquire image data associated with each pixel included in a particular scan line.

FIG. 2E is a diagrammatic representation of vehicle control systems, according to examples of the presently disclosed subject matter. As indicated in FIG. 2E, vehicle 2200 can include throttling system 2220, braking system 2230, and steering system 2240. System 1000 can provide inputs (e.g., control signals) to one or more of throttling system 2220, braking system 2230, and steering system 2240 over one or more data links (e.g., any wired or wireless link or links for transmitting data). For example, based on analysis of images acquired by image capture devices 1122, 1124, or 1126, system 1000 can provide control signals to one or more of throttling system 2220, braking system 2230, and steering system 2240 to navigate vehicle 2200 (e.g., by causing an acceleration, a turn, a lane shift, etc.). Further, system 1000 can receive inputs from one or more of throttling system 2220, braking system 2230, and steering system 2240 indicating operating conditions of vehicle 2200 (e.g., speed, whether vehicle 2200 is braking or turning, etc.).

FIG. 3 is a diagrammatic representation of a user interface 1170 consistent with the disclosed embodiments. As shown in FIG. 3, vehicle 2200 may also include a user interface 1170 for interacting with a driver or a passenger of vehicle 2200. The user interface 1170 may include one or more sensors positioned near a rear-view mirror 3310 or a console display 3320. For example, user interface 1170 in a vehicle application may include a touch screen display 3320, knobs 3330, buttons 3340, and a microphone 3350. A driver or passenger of vehicle 2200 may also use handles (e.g., turn signal handles located on or near the steering column of vehicle 2200), buttons (e.g., located on the steering wheel of vehicle 2200), and the like, to interact with system 1000. In some embodiments, a microphone 3350 may be positioned adjacent to a rearview mirror 3310. Similarly, in some embodiments, image capture device 1122 may be located near rearview mirror 3310. In some embodiments, user interface 1170 may also include one or more speakers 3360 (e.g., speakers of a vehicle audio system). For example, system 1000 may provide various notifications (e.g., alerts) via speakers 3360.

As will be appreciated by a person skilled in the art having the benefit of this disclosure, numerous variations or modifications may be made to the foregoing disclosed embodiments. For example, not all components are essential for the operation of system 1000. Further, any component may be located in any appropriate part of system 1000 and the components may be rearranged into a variety of configurations while providing the functionality of the disclosed embodiments. Therefore, the foregoing configurations are examples and, regardless of the configurations discussed above, system 1000 can provide a wide range of functionality to analyze the surroundings of vehicle 2200 and, in response to this analysis, navigate or otherwise control or operate vehicle 2200. Navigation, control, or operation of vehicle 2200 may include enabling or disabling (directly or via intermediary controllers, such as the controllers mentioned above) various features, components, devices, modes, systems, or subsystems associated with vehicle 2200. Navigation, control, or operation may alternately or additionally include interaction with a user, driver, passenger, passerby, or other vehicle or user, which may be located inside or outside vehicle 2200, for example by providing visual, audio, haptic, or other sensory alerts or indications.

As discussed below in further detail and consistent with various disclosed embodiments, system 1000 may provide a variety of features related to autonomous driving, semi-autonomous driving or driver assist technology. For example, system 1000 may analyze image data, position data (e.g., GPS location information), map data, speed data, or data from sensors included in vehicle 2200. System 1000 may collect the data for analysis from, for example, image acquisition unit 1120, position sensor 1130, and other sensors. Further, system 1000 may analyze the collected data to determine whether or not vehicle 2200 should take a certain action, and then automatically take the determined action without human intervention. It would be appreciated that in some cases, the actions taken automatically by the vehicle are under human supervision, and the ability of the human to intervene adjust abort or override the machine action is enabled under certain circumstances or at all times. For example, when vehicle 2200 navigates without human intervention, system 1000 may automatically control the braking, acceleration, or steering of vehicle 2200 (e.g., by sending control signals to one or more of throttling system 2220, braking system 2230, and steering system 2240). Further, system 1000 may analyze the collected data and issue warnings, indications, recommendations, alerts, or instructions to a driver, passenger, user, or other person inside or outside of the vehicle (or to other vehicles) based on the analysis of the collected data. Additional details regarding the various embodiments that are provided by system 1000 are provided below.

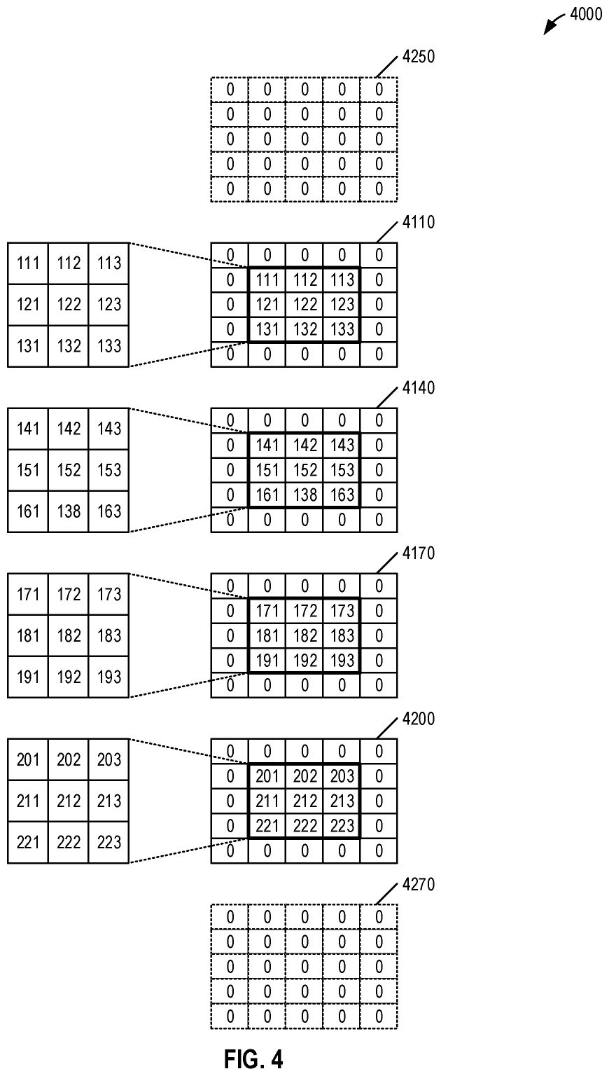

FIGS. 4-8 illustrate input data segments, padded input data segments, virtual padding segments, kernel segments, and output segments. The number of elements per segment may differ from those illustrated in FIGS. 4-8. The number of segments may differ from those illustrated in FIGS. 4-8. For example, the input data segments may include more than 3×3 input data elements, may include less than 3×3 input data elements, the number of input data segments may exceed four or may be less than four, the kernel segments may include more than 3×3 kernel elements, may include less than 3×3 kernel elements, the number of kernel segments may be less than three or may be more than three, the output segments may include more than 3×3 output elements, may include less than 3×3 output elements, the number of output segments may exceed four or may be less than four, the number of virtual padding segments may differ from two, the number of zero-value elements of a virtual padding segment may exceed 3×3 or may be lower than 3×3.

FIG. 4 illustrates an example 4000 of input data segments, padded input data segments, and virtual padding segments, consistent with the disclosed embodiments. The input data includes four input data segments, first input data segment 4110 (having a first input data depth value), second input data segment 4140 (having a second input data depth value), third input data segment 4170 (having a third input data depth value), and a fourth input data segment 4200 (having a fourth input data depth value).

The first input data segment 4110 includes (from top left to bottom right), nine first input data elements 111, 112, 113, 121, 122, 123, 131, 132, and 133. The second input data segment 4140 includes (from top left to bottom right), nine second input data elements 141, 142, 143, 151, 152, 153, 161, 162, and 163. The third input data segment 4170 includes (from top left to bottom right), nine third input data elements 171, 172, 173, 181, 182, 183, 191, 192, and 193. The fourth input data segment 4200 includes (from top left to bottom right), nine fourth input data elements 201, 202, 203, 211, 212, 213, 221, 222, and 223.

The first padded input data segment 4110 includes twenty-five first padded input data segment elements 4110(1,1)-4110(5,5) that include the nine first input data elements that are surrounded by a top row, bottom row, leftmost column, and rightmost column of zero-value elements. The second padded input data segment 4140 includes twenty-five second padded input data segment elements 4140(1,1)-4140(5,5) that include the nine second input data elements that are surrounded by a top row, bottom row, leftmost column, and rightmost column of zero-value elements. The third padded input data segment 4170 includes twenty-five third padded input data segment elements 4170(1,1)-4170(5,5) that include the nine third input data elements that are surrounded by a top row, bottom row, leftmost column, and rightmost column of zero-value elements. The fourth padded input data segment 4200 includes twenty-five fourth padded input data segment elements 4200(1,1)-4200(5,5) that include the nine fourth input data elements that are surrounded by a top row, bottom row, leftmost column, and rightmost column of zero-value elements.

A first virtual padding segment 4250 includes twenty-five first padding elements 4250(1,1)-4250(5,5) of zero-value. A second virtual padding segment 4270 includes twenty-five second padding elements 4270(1,1)-4270(5,5) of zero-value.

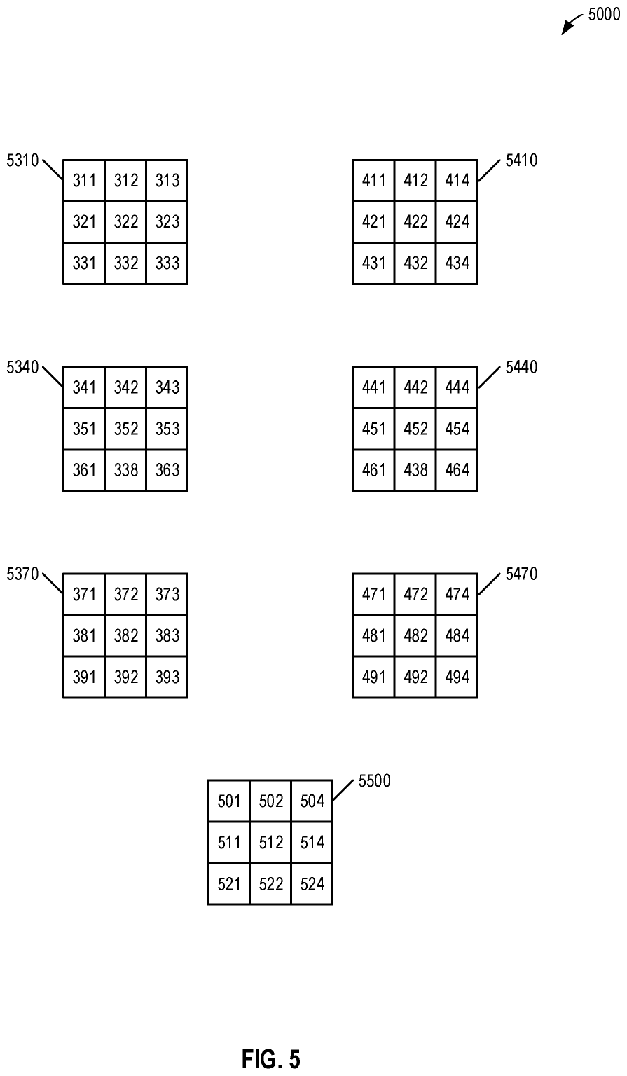

FIG. 5 illustrates an example 5000 of kernel segments, and output segments. The kernel includes three kernel segments: first kernel segment 5310 (having a first kernel depth value), second kernel segment 5340 (having a second kernel depth value), and third kernel segment 5370 (having a third kernel depth value).

The output includes four output segments: first output segment 5410 (having a first output depth value), second output segment 5440 (having a second output depth value), third output segment 5470 (having a third output depth value), and fourth output segment 5500 (having a fourth output depth value).

The calculation of the convolution operation may include four convolution iterations, such as illustrated by TABLE 1:

TABLE 1

| | First allocated | Second allocated | Third allocated | Output |
|---|---|---|---|---|
| # | pairs of segments | pairs of segments | pairs of segments | segment |
| 1 | 4250, 5310 | 4110, 5340 | 4140, 5370 | 5410 |
| 2 | 4110, 5310 | 4140, 5340 | 4170, 5370 | 5440 |
| 3 | 4140, 5310 | 4170, 5340 | 4200, 5370 | 5470 |
| 4 | 4170, 5310 | 4200, 5340 | 4270, 5370 | 5500 |

The kernel segments scan the input data segments or the virtual padding segments by performing sub-iterations. Each sub-iteration involves performing element-wise multiplications and additions operations. Each sub-iteration (except the last one) is followed by moving the kernel segments in relation to the input data segments or the virtual padding segments. Examples of few sub-iterations of the first convolution iteration are illustrated below.

During the first sub-iteration the element-wise multiplications output element 411 is calculated as a sum of (a) a sum of products of element-wise multiplications between the elements of the first kernel segment 5310 and 4250(1,1), 4250(1,2), 4250(1,3), 4250(2,1), 4250(2,2), 4250(2,3), 4250(3,1), 4250(3,2) and 4250(3,3), (b) a sum of products of element-wise multiplications between the elements of the second kernel segment 5340 and 4110(1,1), 4110(1,2), 4110(1,3), 4110(2,1), 4110(2,2), 4110(2,3), 4110(3,1), 4250(3,2) and 4110(3,3), and (c) a sum of products of element-wise multiplications between the elements of the third kernel segment 5370 and 4140(1,1), 4140(1,2), 4140(1,3), 4140(2,1), 4140(2,2), 4140(2,3), 4140(3,1), 4250(3,2) and 4140(3,3).

During the second sub-iteration the element-wise multiplications output element 412 is calculated as a sum of (a) a sum of products of element-wise multiplications between the elements of the first kernel segment 5310 and 4250(1,2), 4250(1,3), 4250(1,4), 4250(2,2), 4250(2,3), 4250(2,4), 4250(3,2), 4250(3,3) and 4250(3,4), (b) a sum of products of element-wise multiplications between the elements of the second kernel segment 5340 and 4110(1,2), 4110(1,3), 4110(1,4), 4110(2,2), 4110(2,3), 4110(2,4), 4110(3,2), 4250(3,3) and 4110(3,4), and (c) a sum of products of element-wise multiplications between the elements of the third kernel segment 5370 and 4140(1,2), 4140(1,3), 4140(1,4), 4140(2,2), 4140(2,3), 4140(2,4), 4140(3,2), 4250(3,3) and 4140(3,4).

During the fourth sub-iteration the element-wise multiplications output element 421 is calculated as a sum of (a) a sum of products of element-wise multiplications between the elements of the first kernel segment 5310 and 4250(2,1), 4250(2,2), 4250(2,3), 4250(3,1), 4250(3,2), 4250(3,3), 4250(4,1), 4250(4,2) and 4250(4,3), (b) a sum of products of element-wise multiplications between the elements of the second kernel segment 5340 and 4110(2,1), 4110(2,2), 4110(2,3), 4110(3,1), 4110(3,2), 4110(3,3), 4110(4,1), 4250(4,2) and 4110(4,3), and (c) a sum of products of element-wise multiplications between the elements of the third kernel segment 5370 and 4140(2,1), 4140(2,2), 4140(2,3), 4140(3,1), 4140(3,2), 4140(3,3), 4140(4,1), 4250(4,2) and 4140(4,3).

During the ninth sub-iteration the element-wise multiplications output element 433 is calculated as a sum of (a) a sum of products of element-wise multiplications between the elements of the first kernel segment 5310 and 4250(3,3), 4250(3,4), 4250(3,5), 4250(4,3), 4250(4,4), 4250(4,5), 4250(5,3), 4250(5,4) and 4250(5,5), (b) a sum of products of element-wise multiplications between the elements of the second kernel segment 5340 and 4110(3,3), 4110(3,4), 4110(3,5), 4110(4,3), 4110(4,4), 4110(4,5), 4110(5,3), 4250(5,4) and 4110(5,5), and (c) a sum of products of element-wise multiplications between the elements of the third kernel segment 5370 and 4140(3,3), 4140(3,4), 4140(3,5), 4140(4,3), 4140(4,4), 4140(4,5), 4140(5,3), 4250(5,4) and 4140(5,5).

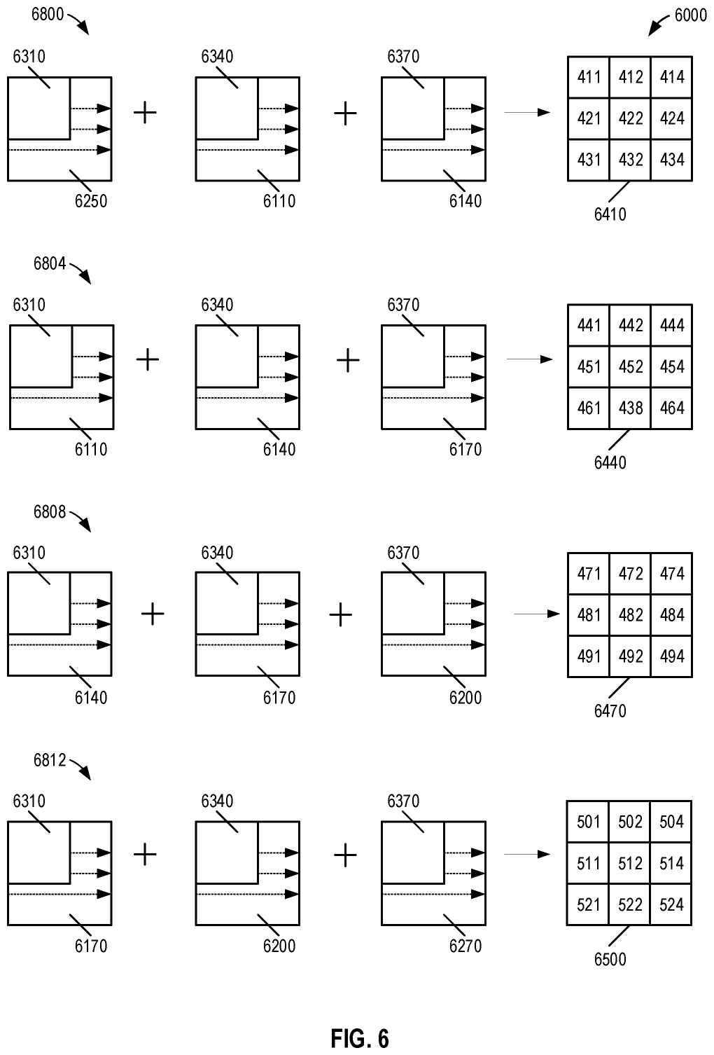

FIG. 6 illustrates an example 6000 of various steps of convolution iterations. The convolution iterations include first inefficient convolution iteration 6800, last inefficient convolution iteration 6812 as well as a second the third convolution iterations 6804 and 6808 that are a first type of convolution iterations.

During the first inefficient convolution iteration 6800 the elements of the first output segment 6410 are calculated by performing nine sub-iterations. Each sub-iteration includes summing (a) a sum of products of element-wise multiplications between elements of first kernel segment 6310 and nine elements of first virtual padding segment 6250, (b) a sum of products of element-wise multiplications between elements of second kernel segment 6340 and nine elements of first padded input data segment 6110, and (c) a sum of products of element-wise multiplications between elements of third kernel segment 6370 and nine elements of second padded input data segment 6140.

During the second convolution iteration 6804, which is a first type convolution iteration, the elements of the second output segment 6440 are calculated by performing nine sub-iterations. Each sub-iteration includes summing (a) a sum of products of element-wise multiplications between elements of first kernel segment 6310 and nine elements of first padded input data segment 6110, (b) a sum of products of element-wise multiplications between elements of second kernel segment 6340 and nine elements of second padded input data segment 6140, and (c) a sum of products of element-wise multiplications between elements of third kernel segment 6370 and nine elements of third padded input data segment 6170.

During the third convolution iteration 6808, which is a first type convolution iteration, the elements of the third output segment 6470 are calculated by performing nine sub-iterations. Each sub-iteration includes summing (a) a sum of products of element-wise multiplications between elements of first kernel segment 6310 and nine elements of second padded input data segment 6140, (b) a sum of products of element-wise multiplications between elements of second kernel segment 6340 and nine elements of third padded input data segment 6170, and (c) a sum of products of element-wise multiplications between elements of third kernel segment 6370 and nine elements of fourth padded input data segment 6200.

During the last inefficient convolution iteration 6812 the elements of the fourth output segment 6500 are calculated by performing nine sub-iterations.

Each sub-iteration includes summing (a) a sum of products of element-wise multiplications between elements of first kernel segment 6310 and nine elements of third padded input data segment 6170, (b) a sum of products of element-wise multiplications between elements of second kernel segment 6340 and nine elements of fourth padded input data segment 6200, and (c) a sum of products of element-wise multiplications between elements of third kernel segment 6370 and nine elements of second virtual padding segment 6270.

Technical solutions described herein provide improvements over first inefficient convolution iteration 6800 and the last inefficient convolution iteration 6812 by reducing or eliminating the need to allocate memory or processing resources on futile calculations regarding elements of virtual padding segments, thereby reducing processing time. These technical solutions include an efficient convolution iteration, which is convolution iteration of a second type. During convolution iteration of a second type, the process skips a calculation of element-wise multiplications and additions operations between elements of the first kernel segment and elements of the virtual padding segment.

According to one example, during convolution iteration of a second type, the efficiency of the calculation of element-wise multiplications and additions operations between elements of the first kernel segment and elements of the virtual padding segment is improved, first by replacing the elements of the first kernel segment by zero-valued elements, and second by performing element-wise multiplications and additions operations between the zero-valued elements and elements of one of the input data segment.

According to another example, during convolution iteration of a second type, the calculation of element-wise multiplications and additions operations between elements of the first kernel segment and elements of the virtual padding segment may be replaced by setting a zero-value to an outcome of the calculation of element-wise multiplications and additions operations between elements of the first kernel segment and elements of the virtual padding segment. This may include not calculating any sum and performing in any sub-iteration fewer sum operations, such as in the examples shown in FIG. 5 and FIG. 6.

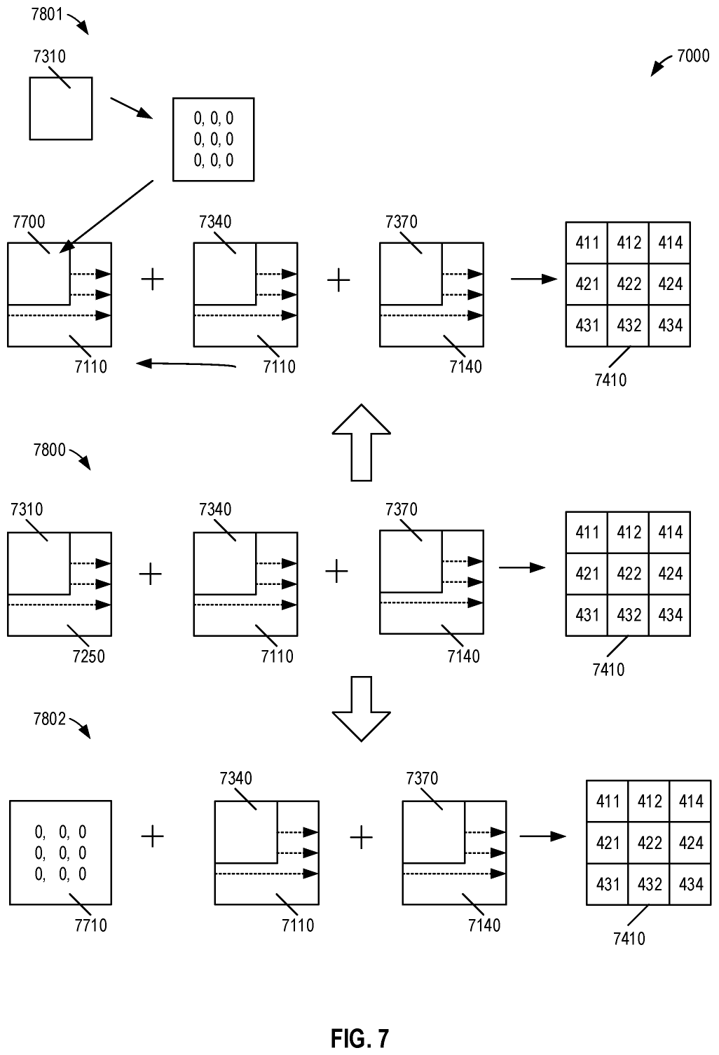

FIG. 7 illustrates examples 7000 of a second type of convolution iteration. Instead of executing inefficient convolution iteration 7800, a second type of convolution iteration may be executed. In a first example, referred to as convolution iteration 7801, the elements of the first kernel segment 7310 in first virtual padding segment 4250 are replaced by zero-valued elements in 7700. The convolution iteration 7801 then performs element-wise multiplications and additions operations between the zero-valued elements and elements of one of the input data segments, such as first input data segment.

Each one of a nine sub-iterations of convolution iteration 7801, includes summing (a) a sum of products of element-wise multiplications between elements of zero-valued elements 7700 and nine elements of first padded input data segment 7110, (b) a sum of products of element-wise multiplications between elements of second kernel segment 7340 and nine elements of first padded input data segment 7110, and (c) a sum of products of element-wise multiplications between elements of third kernel segment 7370 and nine elements of second padded input data segment 7140. These nine sub-iterations of first example convolution iteration 7801 are used to generate first example output segment 7410.

In a second example, referred to as convolution iteration 7802, zero-values (e.g., nine zero-valued elements 7710) are set to an outcome of the calculation of element-wise multiplications and additions operations between elements of the first kernel segment and elements of the first virtual padding segment (not shown). This example setting of zero-values setting may include refraining from executing calculations related to the nine zero-value elements 7710.

Each one of a nine sub-iterations of convolution iteration 7802, includes summing (a) a sum of products of element-wise multiplications between elements of second kernel segment 7340 and nine elements of first padded input data segment 7110, and (b) a sum of products of element-wise multiplications between elements of third kernel segment 7370 and nine elements of second padded input data segment 7140. These nine sub-iterations of second example convolution iteration 7802 are used to generate second example output segment 7410.

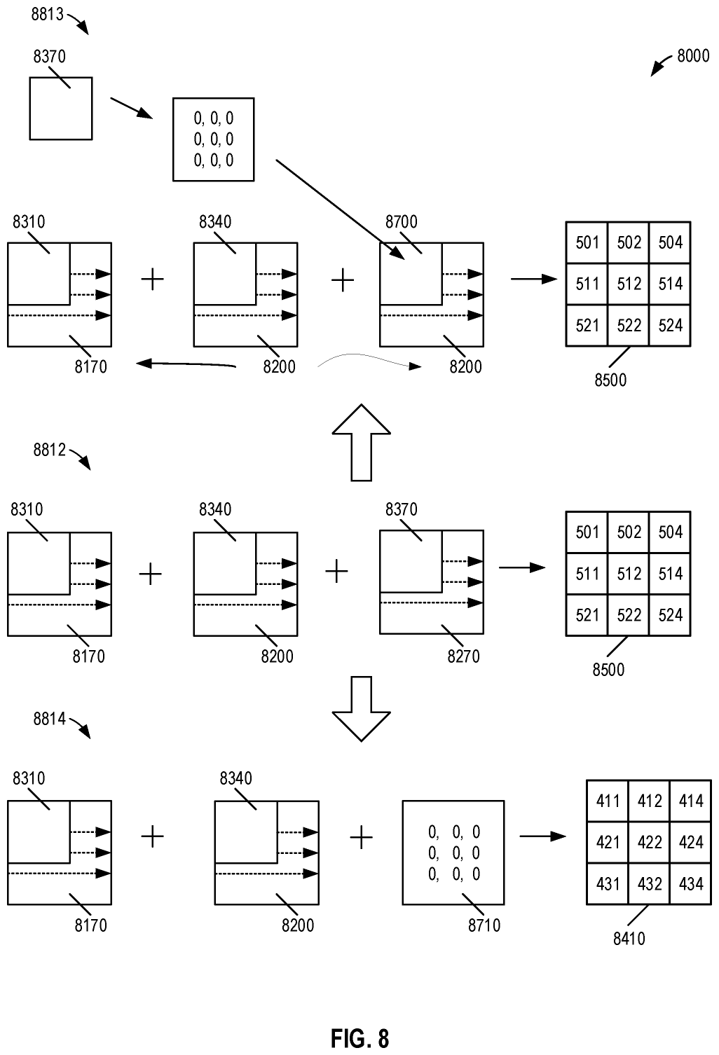

FIG. 8 illustrates two examples 8000 of a second type of convolution iteration. Instead of executing inefficient convolution iteration 8812, a second type of convolution iteration may be executed. In a first example, referred to as convolution iteration 8813, the elements of the third kernel segment 8370 are replaced by zero-valued elements 8700.

Each one of a nine sub-iterations of convolution iteration 8801, includes summing (a) a sum of products of element-wise multiplications between elements of zero-valued elements 8700 and nine elements of first padded input data segment 8110, (b) a sum of products of element-wise multiplications between elements of second kernel segment 8340 and nine elements of first padded input data segment 8110, and (c) a sum of products of element-wise multiplications between elements of third kernel segment 8370 and nine elements of second padded input data segment 8140. These nine sub-iterations of first example convolution iteration 8801 are used to generate first example output segment 8410.

In a second example, referred to as convolution iteration 8814, zero-values (e.g., nine zero-valued elements 8710) are set to an outcome of the calculation of element-wise multiplications and additions operations between elements of the third kernel segment and elements of the second virtual padding segment (not shown). This example setting of zero-values setting may include refraining from executing calculations related to the nine zero-value elements 8710.

Each one of a nine sub-iterations of convolution iteration 8802, includes summing (a) a sum of products of element-wise multiplications between elements of second kernel segment 8340 and nine elements of first padded input data segment 8110, and (b) a sum of products of element-wise multiplications between elements of third kernel segment 8370 and nine elements of second padded input data segment 8140. These nine sub-iterations of second example convolution iteration 8802 are used to generate second example output segment 8410.

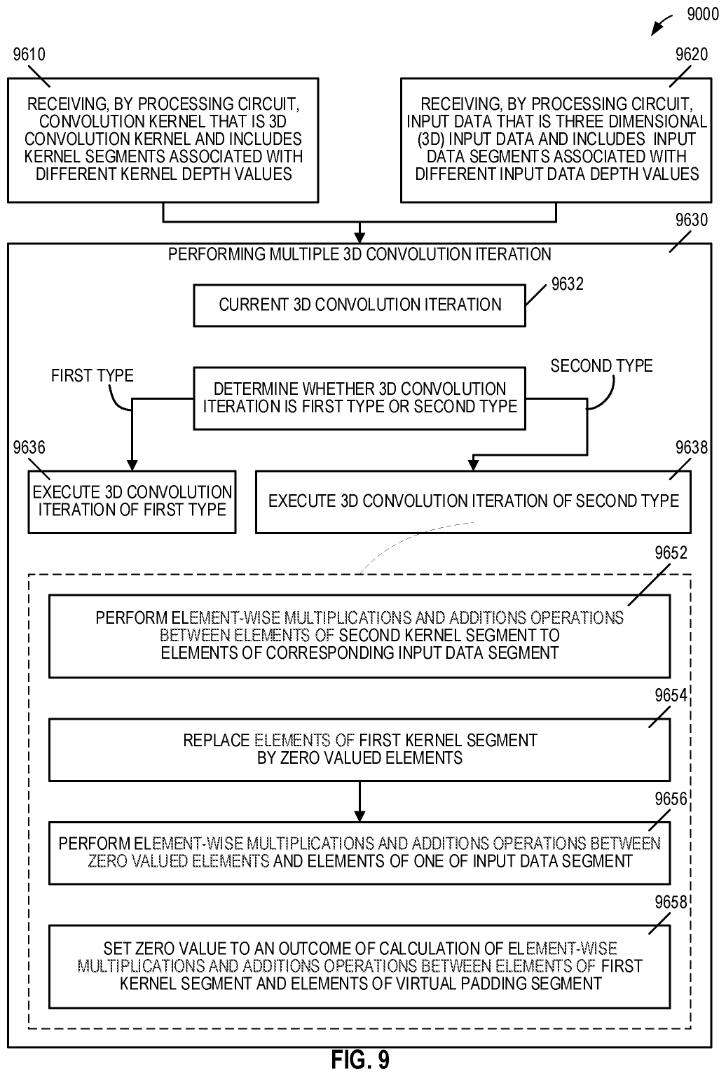

FIG. 9 illustrates an example of method 9000 for neural network convolution. Method 9000 may include step 9610 receiving, by processing circuitry, a convolution kernel that is a 3D convolution kernel and includes kernel segments associated with different kernel depth values. Method 9000 may include step 9620 of receiving, by processing circuitry, input data that includes 3D input data and includes input data segments associated with different input data depth values.

Steps 9610 and 9620 may be followed by step 9630 of performing multiple 3D convolution iteration. Multiple 3D convolution iterations may be used, and each integration may be associated with different depth values of padded input data segments. The multiple 3D convolution iteration may scan the padded input data along its z-axis.

Each 3D convolution iteration (denoted by step 9632, current 3D convolution iteration) may include steps 9634, 9636, and 9638. Step 9634 may include determining whether the 3D convolution iteration of a first type or of a second type. The determination depends on the segments involved in the 3D convolution iteration, especially whether the 3D convolution iteration (if executed in an inefficient manner) should involve a padding segment. A 3D convolution iteration of a first type includes allocating to each one of the kernel segments to a corresponding input data segment. A 3D convolution iteration differs from the 3D convolution iteration of the first type.

Step 9634 may be followed by step 9636 of executing the 3D convolution iteration of the first type, such as when determining that the 3D convolution iteration is of the first type. Step 9634 may be followed by step 9638 of executing the 3D convolution iteration of the second type, such as when determining that the 3D convolution iteration is of the second type. The execution of the convolution of the second type includes skipping a calculation of element-wise multiplications and additions operations between elements of the first kernel segment and elements of a virtual padding segment.

Step 9638 may include steps 9652, 9654, and 9656. Alternatively, step 9638 may include steps 9652 and 9658. Step 9652 may include performing element-wise multiplications and additions operations between elements of a second kernel segment to elements of a corresponding input data segment. See, for example, in FIG. 7, calculating a sum of products of element-wise multiplications between elements of second kernel segment 7340 and nine elements of first padded input data segment 7110. Another example from FIG. 8 includes calculating a sum of products of element-wise multiplications between elements of third kernel segment 8370 and nine elements of second padded input data segment 8140.

Step 9654 may include replacing the elements of the first kernel segment by zero-valued elements. For example, retrieving zero-valued elements from a memory instead of retrieving. Step 9654 may be followed by step 9656 of performing element-wise multiplications and additions operations between the zero-valued elements and elements of one of the input data segments. Regarding steps 9654 and 9656, such as in the example shown in FIG. 7, calculating a sum of products of element-wise multiplications between elements of zero-valued elements 7700 and nine elements of first padded input data segment 7110.

Step 9658 may include setting a zero-value to an outcome of the calculation of element-wise multiplications and additions operations between elements of the first kernel segment and elements of the virtual padding segment. For example, this may include the setting of nine zero-valued elements 7710 shown in FIG. 7. In this case each one of a nine sub-iterations of 3D convolution iteration 7802, includes summing (a) a sum of products of element-wise multiplications between elements of second kernel segment 7340 and nine elements of first padded input data segment 7110, and (b) a sum of products of element-wise multiplications between elements of third kernel segment 7370 and nine elements of second padded input data segment 7140. It should be noted that all the input data segments may belong to a single input data channel.

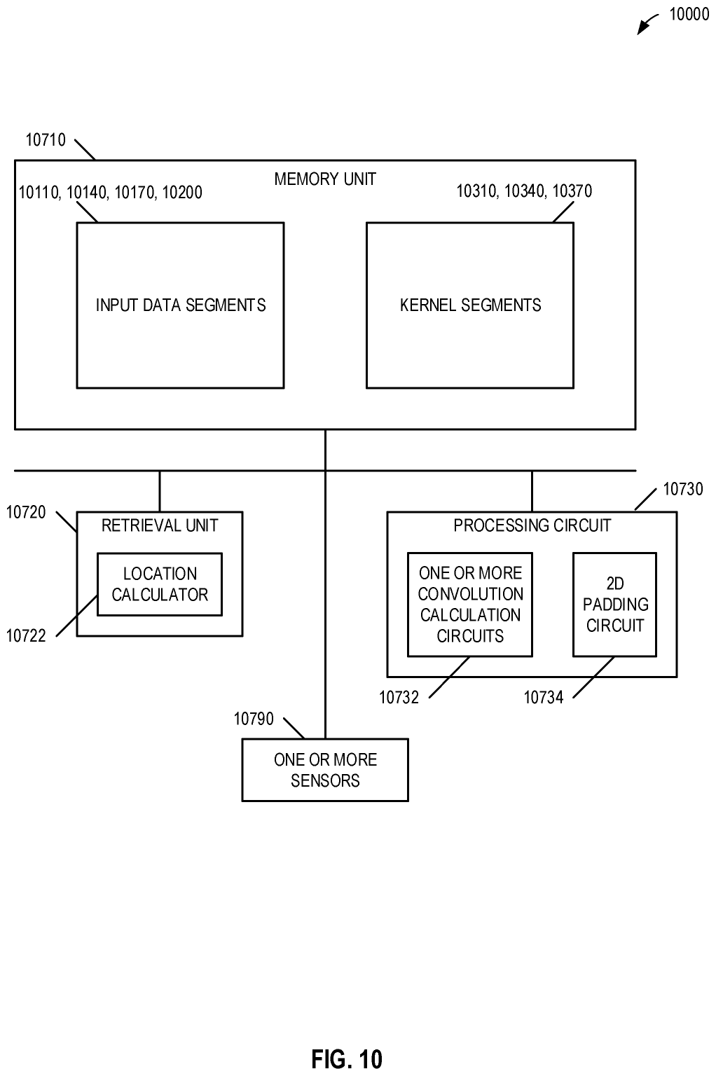

FIG. 10 illustrates an example of a device 10000. Device 10000 may include a memory unit 10710, a retrieval unit 10720, one or more sensors 10790, and processing circuitry 10730. The one or more sensors 10790 may be vehicle sensors, may include a vehicle sensor and a sensor that is not a vehicle sensor, and the like. The device 10000 may be configured to execute method 9000.

Memory unit 10710 may store one or more input data segments 10110, 10140, 10170, 10200, and convolution kernel segments 10310, 10340, 10370. Memory unit 10710 (or another memory unit) may also store instructions for executing method 9000.

The processing circuitry 10730 may include one or more convolution calculation circuits 10732 that may be arithmetic logic units, convolution hardware accelerators, and the like. The processing circuitry 10730 may include one or more 2D padding circuits 10734.

The retrieval unit 10720 may include a location calculator 10722. The location calculator 10722 may be configured to calculate the locations of downsampled data elements within upsampled version of the downsampled data. The location calculator is also configured to calculate retrieval metadata for retrieving one or more of the downsampled data elements. The location calculator 10722 may be or may include an address generation unit (AGU). The location calculator 10722 may be configured to execute only one of (a) calculating the locations of downsampled data elements within upsampled version of the downsampled data, and (b) calculating the retrieval metadata. The location calculator 10722 may not belong to the retrieval unit 10720.

The processing circuitry 10730 is configured to calculate a transposed convolution result by applying a convolution kernel on the downsampled data elements of the upsampled version of the downsampled data to provide a transposed convolution outcome.

The subject matter may also be implemented in a computer program for running on a computer system, at least including code portions for performing steps of a method according to the subject matter when run on a programmable apparatus, such as a computer system or enabling a programmable apparatus to perform functions of a device or system according to the subject matter. The computer program may cause the storage system to allocate disk drives to disk drive groups.

A computer program is a list of instructions such as a particular application program or an operating system. The computer program may for instance include one or more of: a subroutine, a function, a procedure, an object method, an object implementation, an executable application, an applet, a servlet, a source code, an object code, a shared library or dynamic load library or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD ROM, CD-R, etc.) and digital video disk storage media; nonvolatile memory storage media including semiconductor-based memory units such as flash memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory, and a number of input/output (I/O) devices. When executing the computer program, the computer system processes information according to the computer program and produces resultant output information via I/O devices.

In the foregoing specification, the subject matter has been described with reference to specific examples of embodiments of the subject matter. It will, however, be evident that various modifications and changes may be made therein without departing from the broader spirit and scope of the subject matter as set forth in the appended claims.

The connections as discussed herein may be any type of connection suitable to transfer signals from or to the respective nodes, units, or devices, for example via intermediate devices. Accordingly, unless implied or stated otherwise, the connections may for example be direct connections or indirect connections. The connections may be illustrated or described in reference to a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

To better illustrate the method and apparatuses disclosed herein, a non-limiting list of example embodiments is provided here.

Example 1 is a method for neural network convolution, the method comprising: receiving, by a processing circuitry, a three dimensional (3D) data input that includes, input data segments associated with different input data depth values; receiving, by the processing circuitry, a convolution kernel that is a 3D convolution kernel and comprises kernel segments associated with different kernel depth values; and performing multiple 3D convolution iterations, wherein each iteration of the multiple 3D convolution iterations comprises: determining a convolution iteration type, the convolution iteration type indicating whether a 3D convolution iteration of the multiple 3D convolutional iterations is of a first convolution iteration type or of a second convolution iteration type; and executing the 3D convolution iteration based on the convolution iteration type.

In Example 2, the subject matter of Example 1 includes, wherein: the convolution iteration type is of the first convolution iteration type; and the execution of the 3D convolution iteration comprises allocating each one of the kernel segments to a corresponding input data segment.

In Example 3, the subject matter of Examples 1-2 includes, wherein: the convolution iteration type is of the second convolution iteration type; and the execution of the 3D convolution iteration comprises skipping a calculation of element-wise multiplication and addition operations between elements of a first kernel segment and elements of a virtual padding segment.

In Example 4, the subject matter of Example 3 includes, wherein the execution of the 3D convolution iteration comprises: performing element-wise multiplication and addition operations between elements of a second kernel segment to elements of a corresponding input data segment; replacing the elements of the first kernel segment by zero-valued elements; and performing element-wise multiplication and addition operations between the zero-valued elements and elements of one of the corresponding input data segments.

In Example 5, the subject matter of Example 4 includes, wherein the replacing the elements of the first kernel segment comprises retrieving zero-valued elements from a memory unit instead of retrieving elements of the first kernel segment.

In Example 6, the subject matter of Examples 3-5 includes, wherein the execution of the 3D convolution iteration comprises: performing element-wise multiplication and addition operations between elements of the second kernel segment to elements of the corresponding input data segment; and setting a zero-value to an outcome of the calculation of element-wise multiplication and addition operations between elements of the first kernel segment and elements of the virtual padding segment.

In Example 7, the subject matter of Examples 1-6 includes, wherein the input data segments belong to a single channel.

Example 8 is at least one non-transitory machine-readable storage medium, comprising a plurality of instructions that, responsive to being executed with processor circuitry of a computing device, cause the computing device to: receive a three dimensional (3D) data input that includes, input data segments associated with different input data depth values; receive a convolution kernel that is a 3D convolution kernel and comprises kernel segments associated with different kernel depth values; and perform multiple 3D convolution iterations, wherein each integration of multiple 3D convolution iterations comprises: determining a convolution iteration type, the convolution iteration type indicating whether a 3D convolution iteration of the multiple 3D convolutional iterations is of a first convolution iteration type or of a second convolution iteration type; and executing the 3D convolution iteration based on the convolution iteration type.

In Example 9, the subject matter of Example 8 includes, wherein: the convolution iteration type is of the first convolution iteration type; and the execution of the 3D convolution iteration comprises allocating each one of the kernel segments to a corresponding input data segment.

In Example 10, the subject matter of Examples 8-9 includes, wherein: the convolution iteration type is of the second convolution iteration type; and the execution of the 3D convolution iteration comprises skipping a calculation of element-wise multiplication and addition operations between elements of a first kernel segment within the kernel segments and elements of a virtual padding segment.

In Example 11, the subject matter of Example 10 includes, wherein the execution of the 3D convolution iteration comprises: performing element-wise multiplication and addition operations between elements of a second kernel segment within the kernel segments to elements of a corresponding input data segment; replacing the elements of the first kernel segment by zero-valued elements; and performing element-wise multiplication and addition operations between the zero-valued elements and elements of one of the corresponding input data segments.

In Example 12, the subject matter of Example 11 includes, wherein the replacing the elements of the first kernel segment comprises retrieving zero-valued elements from a memory unit instead of retrieving elements of the first kernel segment.

In Example 13, the subject matter of Examples 11-12 includes, wherein the execution of the 3D convolution iteration comprises: performing element-wise multiplication and addition operations between elements of the second kernel segment to elements of the corresponding input data segment; and setting a zero-value to an outcome of the calculation of element-wise multiplication and addition operations between elements of the first kernel segment and elements of the virtual padding segment.

In Example 14, the subject matter of Examples 10-13 includes, wherein the execution of the 3D convolution iteration comprises allocating the first kernel segment to virtual padding segments and allocating the second kernel segment to the corresponding input data segment.

In Example 15, the subject matter of Examples 8-14 includes, wherein the input data segments belong to a single channel.

Example 16 is a device for neural network convolution, the device comprising: processing circuitry configured to: receive a three dimensional (3D) data input from a depth image capture device, the 3D data input including input data segments associated with different input data depth values; receive a convolution kernel that is a 3D convolution kernel and comprises kernel segments associated with different kernel depth values; and perform multiple 3D convolution iterations, wherein each iteration of the multiple 3D convolution iterations comprises: determining a convolution iteration type, the convolution iteration type indicating whether a 3D convolution iteration of the multiple 3D convolutional iterations is of a first convolution iteration type or of a second convolution iteration type; and executing the 3D convolution iteration based on the convolution iteration type.

In Example 17, the subject matter of Example 16 includes, wherein: the convolution iteration type is of the first convolution iteration type; and the execution of the 3D convolution iteration comprising allocating each one of the kernel segments to a corresponding input data segment.

In Example 18, the subject matter of Examples 16-17 includes, wherein: the convolution iteration type is of the second convolution iteration type; and the execution of the 3D convolution iteration comprises skipping a calculation of element-wise multiplication and addition operations between elements of a first kernel segment within the kernel segments and elements of a virtual padding segment.

In Example 19, the subject matter of Example 18 includes, wherein the processing circuitry is configured to execute the second convolution iteration type by: performing element-wise multiplication and addition operations between elements of a second kernel segment within the kernel segments to elements of a corresponding input data segment; replacing the elements of the first kernel segment by zero-valued elements; and performing element-wise multiplication and addition operations between the zero-valued elements and elements of one of the corresponding input data segments.

In Example 20, the subject matter of Example 19 includes, wherein the replacing comprises retrieving zero-valued elements from a memory unit instead of retrieving elements of the first kernel segment.

In Example 21, the subject matter of Examples 16-20 includes, wherein the processing circuitry is configured to execute the second convolution iteration type by: performing element-wise multiplication and addition operations between elements of the second kernel segment to elements of the corresponding input data segment; and setting a zero-value to an outcome of the calculation of element-wise multiplication and addition operations between elements of the first kernel segment and elements of the virtual padding segment.

In Example 22, the subject matter of Examples 18-21 includes, wherein the input data segments belong to a single channel.

Example 23 is at least one machine-readable medium including instructions that, when executed by processing circuitry, cause the processing circuitry to perform operations to implement of any of Examples 1-22.

Example 24 is an apparatus comprising means to implement of any of Examples 1-22.

Example 25 is a system to implement of any of Examples 1-22.

Example 26 is a method to implement of any of Examples 1-22.

The illustrated examples may be implemented as circuitry located on a single integrated circuit or within a same device. Alternatively, the examples may be implemented as any number of separate integrated circuits or separate devices interconnected with each other in a suitable manner. The examples, or portions thereof, may implemented as soft or code representations of physical circuitry or of logical representations convertible into physical circuitry, such as in a hardware description language of any appropriate type. The subject matter is not limited to physical devices or units implemented in non-programmable hardware but may also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as “computer systems.” Other modifications, variations, and alternatives are also possible. The specifications and drawings are, accordingly, to be regarded in an illustrative rather than in a restrictive sense.

In the claims, any reference signs placed between parentheses shall not be construed as limiting the claim. The word “comprising” does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to subject matter containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the subject matter have been illustrated and described herein, many modifications, substitutions, changes, and equivalents will now occur to those of ordinary skill in the art. It is, therefore, to be understood that the appended claims are intended to cover all such modifications and changes as fall within the true spirit of the subject matter.

1. A method for neural network convolution, the method comprising:
receiving, by a processing circuitry, a three dimensional (3D) data input that includes input data segments associated with different input data depth values;
receiving, by the processing circuitry, a convolution kernel that is a 3D convolution kernel and comprises kernel segments associated with different kernel depth values; and
performing multiple 3D convolution iterations, wherein each iteration of the multiple 3D convolution iterations comprises:
determining a convolution iteration type, the convolution iteration type indicating whether a 3D convolution iteration of the multiple 3D convolutional iterations is of a first convolution iteration type or of a second convolution iteration type; and
executing the 3D convolution iteration based on the convolution iteration type.

2. The method according to claim 1, wherein:
the convolution iteration type is of the first convolution iteration type; and
the execution of the 3D convolution iteration comprises allocating each one of the kernel segments to a corresponding input data segment.

3. The method according to claim 1, wherein:
the convolution iteration type is of the second convolution iteration type; and
the execution of the 3D convolution iteration comprises skipping a calculation of element-wise multiplication and addition operations between elements of a first kernel segment and elements of a virtual padding segment.

4. The method according to claim 3, wherein the execution of the 3D convolution iteration comprises:
performing element-wise multiplication and addition operations between elements of a second kernel segment to elements of a corresponding input data segment;
replacing the elements of the first kernel segment by zero-valued elements; and
performing element-wise multiplication and addition operations between the zero-valued elements and elements of one of the corresponding input data segments.

5. The method according to claim 4, wherein the replacing the elements of the first kernel segment comprises retrieving zero-valued elements from a memory unit instead of retrieving elements of the first kernel segment.

6. The method according to claim 3, wherein the execution of the 3D convolution iteration comprises:
performing element-wise multiplication and addition operations between elements of the second kernel segment to elements of the corresponding input data segment; and
setting a zero-value to an outcome of the calculation of element-wise multiplication and addition operations between elements of the first kernel segment and elements of the virtual padding segment.

7. The method according to claim 1, wherein the input data segments belong to a single channel.

8. At least one non-transitory machine-readable storage medium, comprising a plurality of instructions that, responsive to being executed with processor circuitry of a computing device, cause the computing device to:
receive a three dimensional (3D) data input that includes input data segments associated with different input data depth values;
receive a convolution kernel that is a 3D convolution kernel and comprises kernel segments associated with different kernel depth values; and
perform multiple 3D convolution iterations, wherein each integration of multiple 3D convolution iterations comprises:
determining a convolution iteration type, the convolution iteration type indicating whether a 3D convolution iteration of the multiple 3D convolutional iterations is of a first convolution iteration type or of a second convolution iteration type; and
executing the 3D convolution iteration based on the convolution iteration type.

9. The at least one non-transitory computer readable medium according to claim 8, wherein:
the convolution iteration type is of the first convolution iteration type; and
the execution of the 3D convolution iteration comprises allocating each one of the kernel segments to a corresponding input data segment.

10. The at least one non-transitory computer readable medium according to claim 8, wherein:
the convolution iteration type is of the second convolution iteration type; and
the execution of the 3D convolution iteration comprises skipping a calculation of element-wise multiplication and addition operations between elements of a first kernel segment within the kernel segments and elements of a virtual padding segment.

11. The at least one non-transitory computer readable medium according to claim 10, wherein the execution of the 3D convolution iteration comprises:
performing element-wise multiplication and addition operations between elements of a second kernel segment within the kernel segments to elements of a corresponding input data segment;
replacing the elements of the first kernel segment by zero-valued elements; and
performing element-wise multiplication and addition operations between the zero-valued elements and elements of one of the corresponding input data segments.

12. The at least one non-transitory computer readable medium according to claim 11, wherein the replacing the elements of the first kernel segment comprises retrieving zero-valued elements from a memory unit instead of retrieving elements of the first kernel segment.

13. The at least one non-transitory computer readable medium according to claim 11, wherein the execution of the 3D convolution iteration comprises:
performing element-wise multiplication and addition operations between elements of the second kernel segment to elements of the corresponding input data segment; and
setting a zero-value to an outcome of the calculation of element-wise multiplication and addition operations between elements of the first kernel segment and elements of the virtual padding segment.

14. The at least one non-transitory computer readable medium according to claim 10, wherein the execution of the 3D convolution iteration comprises allocating the first kernel segment to virtual padding segments and allocating the second kernel segment to the corresponding input data segment.

15. The at least one non-transitory computer readable medium according to claim 8, wherein the input data segments belong to a single channel.

16. A device for neural network convolution, the device comprising:
processing circuitry configured to:
receive a three dimensional (3D) data input from a depth image capture device, the 3D data input including input data segments associated with different input data depth values;
receive a convolution kernel that is a 3D convolution kernel and comprises kernel segments associated with different kernel depth values; and
perform multiple 3D convolution iterations, wherein each iteration of the multiple 3D convolution iterations comprises:
determining a convolution iteration type, the convolution iteration type indicating whether a 3D convolution iteration of the multiple 3D convolutional iterations is of a first convolution iteration type or of a second convolution iteration type; and
executing the 3D convolution iteration based on the convolution iteration type.

17. The device according to claim 16, wherein:
the convolution iteration type is of the first convolution iteration type; and
the execution of the 3D convolution iteration comprising allocating each one of the kernel segments to a corresponding input data segment.

18. The device according to claim 16, wherein:
the convolution iteration type is of the second convolution iteration type; and
the execution of the 3D convolution iteration comprises skipping a calculation of element-wise multiplication and addition operations between elements of a first kernel segment within the kernel segments and elements of a virtual padding segment.

19. The device according to claim 18, wherein the processing circuitry is configured to execute the second convolution iteration type by:
performing element-wise multiplication and addition operations between elements of a second kernel segment within the kernel segments to elements of a corresponding input data segment;
replacing the elements of the first kernel segment by zero-valued elements; and
performing element-wise multiplication and addition operations between the zero-valued elements and elements of one of the corresponding input data segments.

20. The device according to claim 19, wherein the replacing comprises retrieving zero-valued elements from a memory unit instead of retrieving elements of the first kernel segment.

21. The device according to claim 16, wherein the processing circuitry is configured to execute the second convolution iteration type by:
performing element-wise multiplication and addition operations between elements of the second kernel segment to elements of the corresponding input data segment; and
setting a zero-value to an outcome of the calculation of element-wise multiplication and addition operations between elements of the first kernel segment and elements of the virtual padding segment.

22. The device according to claim 18, wherein the input data segments belong to a single channel.
